(19) United States
(12) Patent Application Publication
(10) Pub. No.: US 2006/0160493 A1
(43) Pub. Date: Jul. 20, 2006

(54) Mobile phone device having inbuilt earphone structure

(75) Inventors: Chengshing Lai, Taipei (TW); Lei Zhang, Nanking City (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/147,339

(22) Filed: Jun. 8, 2005

(30) Foreign Application Priority Data
Jan. 19, 2005 (TW) 094101600

(51) Int. Cl. H04B 1/38

(52) U.S. Cl. 455/90.3

(57) ABSTRACT

A mobile phone having an inbuilt earphone structure comprises a main body, an earphone and a reel. The main body comprises a space. The earphone has a transmission line and is detachable attaching to the main body by the transmission line. The reel is located in the main body for rolling up the transmission line, so that the transmission line can be stored in the space.

### BACKGROUND OF THE INVENTION

1. Field of Invention

The invention relates to a communication device and, in particular, to a mobile phone.

2. Related Art

If one would like to use a mobile phone to catch the voice, such as speech sound or music, with an earphone, he/she must firstly insert a wired or wireless earphone to the mobile phone. In such a case, the user must prepare the earphone in advance and carry it all the time, so that the earphone can be connected to the mobile phone as desired.

Regarding to the user, the conventional earphone is separated from the mobile phone. Thus, the earphone and the mobile phone are separately carried by the user. Besides, the conventional wired earphone may result in the inconvenience of the user caused by the entwined wire. If the earphone is not in use, the user must roll up it for preservation additionally.

It is therefore an important subject of the invention to provide a mobile phone having an inbuilt earphone structure, which can facilitate the user to carry or use the earphone.

### SUMMARY OF THE INVENTION

In view of the foregoing, the invention is to provide a mobile phone having an inbuilt earphone structure.

To achieve the above, a mobile phone of the invention comprises a main body, an earphone and a reel. The main body comprises a space. The earphone has a transmission line and is detachable attaching to the main body by the transmission line. The reel is located in the main body for rolling up the transmission line, so that the transmission line can be stored in the space.

As mentioned above, the mobile phone of the invention, which has an inbuilt earphone structure, includes a space and a reel for rolling up the transmission line of the earphone inside the main body of the mobile phone.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a mobile phone having an inbuilt earphone structure according to a preferred embodiment of the invention;

FIG. 2 is a partial enlarged diagram showing a transmission line and a stopper of the mobile phone according to the preferred embodiment of the invention; and

FIG. 3 is a partial enlarged diagram showing the transmission line and another stopper of the mobile phone according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

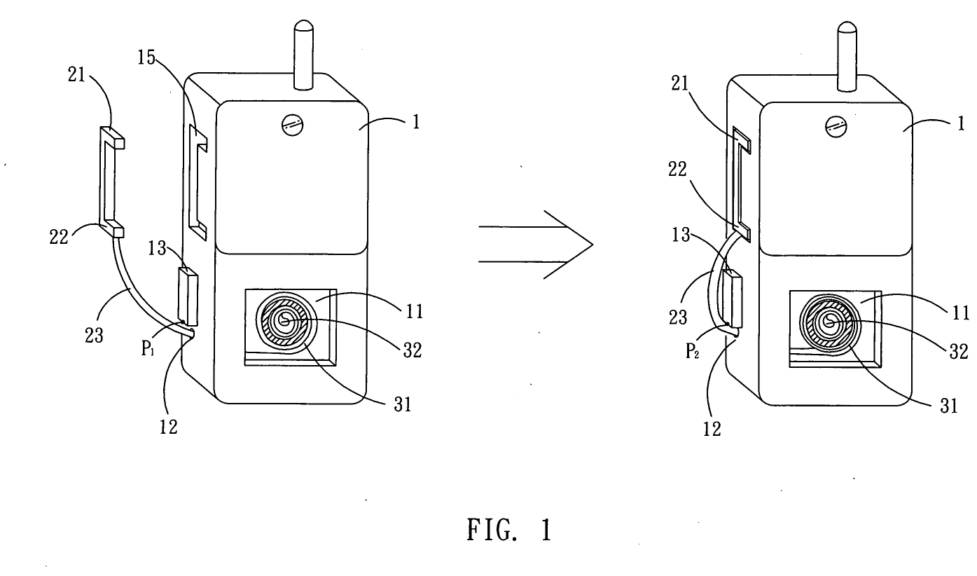

With reference to FIG. 1, a mobile phone having an inbuilt earphone structure according to a preferred embodiment of the invention includes a main body 1, an earphone 2 and a reel 3. In the embodiment, the main body 1 includes a space 11. The earphone 2 includes a receiver 21, a phone 22, and a transmission line 23. In particular, the receiver 21 can be a microphone, and the phone 22 can be a conventional earphone. The earphone 2 is detachable attaching to the main body 1, by the transmission line 23. In this embodiment, one end of the transmission line 23 connects to the earphone 2, and the other end thereof connects to the main body 1. In details, the other end of the transmission line 23 can be weld to the main body 1. The reel 3 is located in the main body 1 for rolling up the transmission line 23, so that the transmission line 23 can be stored in the space 11.

Furthermore, the reel 3 includes a shaft 31 and a torsion spring 32. The shaft 31 is used for rolling up the transmission line 23. The torsion spring 32 connects the main body 1 and the shaft 31. In this case, the torsion spring 32 drives the shaft 31 so as to roll up the transmission line 23.

The main body 1 further includes a hole 12, a stopper 13 and a recessed portion 15. In this embodiment, the transmission line 23 passes through the hole 12. The stopper 13 is movably disposed on the main body 1. When the stopper 13 is located at a first position P₁, the transmission line 23 is capable of being reeled in via the hole 12. In this situation, the transmission line 23 can be pulled out by the user for the further usage, or it can be rolled up with the shaft 31 rotated by the torsion spring 32. Regarding to the former case, when the user thinks that the pulled transmission line 23 is suitable for use, he/she can push the stopper 13 from the first position P₁ to a second position P₂. In this situation, the transmission line 23 is fastened to the hole 12 with the stopper 13. In other words, the transmission line 23 can not be pulled out by the user or be rolled up with the shaft 31. Accordingly, the user can easily control the length of the transmission line 23 exposed from the main body 1. Moreover, when the receiver 21 and the phone 22 are not in use, the earphone 2 can be inserted into the recessed portion 15.

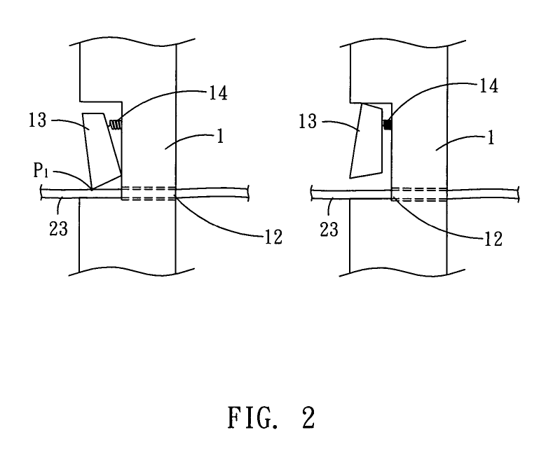

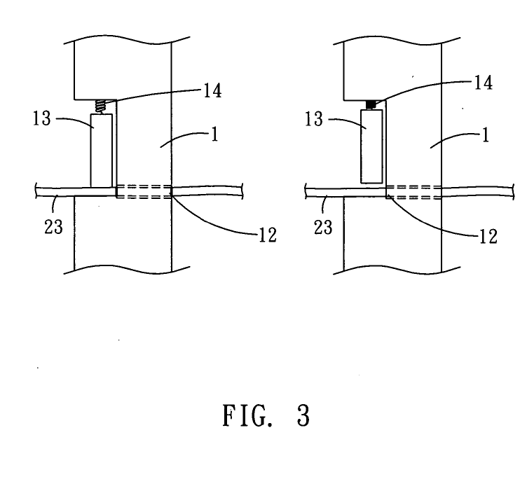

With reference to FIGS. 2 and 3, the main body may further include a resilient member 14. When the stopper 13 is pushed, the resilient member 14 is compressed and the stopper 13 is moved from the first position P₁ to the second position P₂. Under this configuration, the user can conveniently control the length of the exposed transmission line 23 by pulling out the transmission line 23 or rolling up it. In practice, the user firstly pushes the stopper 13 from the first position P₁ to the second position P₂, and then pulls out the transmission line 23 or lets the reel 3 roll up the transmission line 23. When the user thinks that the length of the exposed transmission line 23 is enough, or that the transmission line 23 has been rolled up in the main body 1 completely, he/she can release the stopper 13. Thus, the stopper 13 can be pushed from the second position P₂ to the first position P₁ by the resilient member 14. Accordingly, the transmission line 23 can be fastened and cannot be pulled out or be rolled up. As shown in FIG. 2, the resilient member 14 is parallel to the direction of part of the transmission line 23 passing through the hole 12. As shown in FIG. 3, the resilient member 14 is perpendicular to the direction of part of the transmission line 23 passing through the hole 12.

In summary, since the mobile phone of the invention includes a space and a reel, the transmission line of the earphone can be rolled up inside the main body of the mobile phone. Therefore, the mobile phone of the invention, which has an inbuilt earphone structure, can facilitate the user to carry or use it.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A mobile phone, comprising:
a main body having a space;
an earphone having a transmission line and detachable attaching to the main body by the transmission line; and
a reel located in the main body to roll up the transmission line, whereby the transmission line is stored in the space.

2. The mobile phone of claim 1, further comprising a microphone connecting the earphone.

3. The mobile phone of claim 1, wherein the reel comprises:
a shaft for rolling up the phone line.

4. The mobile phone of claim 3, wherein the reel further comprises:
a torsion spring connecting the main body and the shaft, wherein the torsion spring drives the shaft to roll up the transmission line.

5. The mobile phone of claim 1, wherein the main body is defined with a hole, and the transmission line passes through the hole.

6. The device of claim 5, wherein the main body comprises:
a stopper movably disposed on the main body, wherein the transmission line is capable of being reeled in via the hole when the stopper is located at a first position, and the transmission line is fastened when the stopper is located at a second position.

7. The mobile phone of claim 6, wherein the main body further comprises:
a resilient member forcing the stopper to move from the first position to the second position.

8. The mobile phone of claim 1, wherein the main body comprises a recessed portion for receiving the earphone.

9. The mobile phone of claim 1, wherein the transmission line has one end welded to the main body.
